(19) United States
(12) Patent Application Publication
(10) Pub. No.: US 2014/0218336 A1
(43) Pub. Date: Aug. 7, 2014

(54) CAPACITIVE TOUCH SCREEN AND INFORMATION PROCESSING METHOD THEREFOR

(71) Applicants: LENOVO (BEIJING) CO., LTD., Beijing (CN); BEIJING LENOVO SOFTWARE LTD., Beijing (CN)

(72) Inventor: Qian ZHAO, Beijing (CN)

(73) Assignees: LENOVO (BEIJING) CO., LTD., Beijing (CN); BEIJING LENOVO SOFTWARE LTD., Beijing (CN)

(21) Appl. No.: 14/166,415

(22) Filed: Jan. 28, 2014

(30) Foreign Application Priority Data
Feb. 4, 2013 (CN) 201310045009.X

(51) Int. Cl. G06F 3/044

(52) U.S. Cl. CPC G06F 3/044
USPC 345/174

(57) ABSTRACT

A capacitive touch screen and an information processing method therefor are disclosed. The capacitive touch screen is provided with a conductor layer and an oscillator for generating an alternate current signal, and the method includes the following steps controlling an oscillation frequency of the oscillator to a first frequency; obtaining a first coupling capacitance value between an operational body and the conductor layer under the first frequency when the operational body carries out a first touch control operation to the capacitive touch screen; changing the first frequency so as to obtain a plurality of first coupling capacitance values; using the plurality of first coupling capacitance values to form a first oscillation frequency-capacitance curve; analyzing the first oscillation frequency-capacitance curve according to a predetermined rule to determine a type of the first touch control operation and/or information of source of the operational body.

### CROSS REFERENCE TO RELATED APPLICATIONS

This application claims the benefit under 35 U.S.C. §119(a) of Chinese Patent Application No. 201310045009.X, filed on Feb. 4, 2013, the entire disclosure of which is incorporated by reference herein in its entirety.

### BACKGROUND

The present invention relates to a capacitive touch screen and an information processing method therefor, more specifically, relates to a capacitive touch screen for distinguishing different people, different gestures, or the like by multi-frequency point sampling and an information processing method therefor.

A capacitive touch screen is a four-layer composite glass screen, internal surface and interlayer of the glass screen are coated with a layer of ITO, and outermost layer is a laminate silica soil glass protective layer, the ITO coating of the interlayer functions as a working face, four electrodes are led from the four corners, the ITO of the inner layer is as a shielding layer to ensure a good working environment. When a finger touches on a metal layer, due to electric field of the human body, the user forms a coupling capacitance with the surface of the touch screen, for high frequency current, capacitance is a direct conductor, thus, the finger absorbs a very small electric current from the contact point. This electric current flows out from the electrodes on the four corners of the touch screen, and the electric current passing the four electrodes are proportional to the distances of the finger to the four corners, a controller derives the position of the touch point by calculating accurately the four proportions of the electric current.

At present, there is only one default frequency of an oscillator, for example 1 MHz. By detecting variation of the capacitance, people can distinguish whether the finger contacts the screen or not. This is a detection in one-dimensional space.

However, with the development of tablet computer having a capacitive touch screen, it desires to provide a detection in more dimensions.

### SUMMARY

In view of the above case, it desires to provide a capacitive touch screen, which can distinguish different people and different gestures or the like and an information processing method therefor.

When sampled points of oscillation frequency are expanded, for example, 1 MHz, 2 MHz, 3 MHz or the like, the current values measured actually are different, this is because that the resistance of the human body are different for different frequencies and the resistance of different gestures of the hand touching the touch screen are different for different frequencies. Therefore, for different people or different gestures, a corresponding wave curve can be obtained. By analyzing the wave curve, different people or different gestures of human hand can be distinguished.

According to one aspect of the present invention, there is provided an information processing method applied in a capacitive touch screen, the capacitive touch screen is provided with a conductor layer and an oscillator for generating an alternate current signal, the method includes steps of controlling an oscillation frequency of the oscillator to a first frequency; obtaining a first coupling capacitance value between an operational body and the conductor layer under the first frequency when there is the operational body carrying out a first touch control operation to the capacitive touch screen; changing the first frequency so as to obtain a plurality of first coupling capacitance values; using the plurality of first coupling capacitance values to form a first oscillation frequency-capacitance curve; analyzing the first oscillation frequency-capacitance curve according to a predetermined rule to determine a type of the first touch control operation and/or information of source of the operational body.

In some embodiments, in the information processing method according to the embodiment of the present invention, the step of analyzing the first oscillation frequency-capacitance curve according to a predetermined rule is specifically matching the first oscillation frequency-capacitance curve to a pre-stored oscillation frequency-capacitance curve, different curves in the pre-stored oscillation frequency-capacitance curve being able to characterize different types of the first touch control operation and/or the information of the source of the operational body.

In some embodiments, in the information processing method according to the embodiment of the present invention, the operational body is a finger of the user, and the information of the source of the operational body refers to information of identity of the user.

In some embodiments, in the information processing method according to the embodiment of the present invention, the step of analyzing the first oscillation frequency-capacitance curve according to a predetermined rule is specifically analyzing curve characteristics of the first oscillation frequency-capacitance curve to determine types of the first touch control operation and/or the information of the source of the operational body.

In some embodiments, in the information processing method according to the embodiment of the present invention, the operational body is a handwritten pen, and the information of the source of the operational body refers to information of the manufacturer of the handwritten pen.

In some embodiments, in the information processing method according to the embodiment of the present invention, when it is determined that the type of the first touch control operation and/or the information of the source of the operational body do not conform to a predetermined condition, the first touch control operation is not responded.

According to another aspect of the present invention, there is provided an capacitive touch screen, including a conductor layer; an oscillator for generating an alternate current signal and of which an oscillation frequency is a first frequency; a coupling capacitance value acquiring unit for obtaining a first coupling capacitance value between an operational body and the conductor layer under the first frequency when there is the operational body carrying out a first touch control operation to the capacitive touch screen; a control unit for controlling the oscillation frequency of the oscillator to a first frequency and changing the first frequency so as to obtain a plurality of first coupling capacitance values; a curve forming unit for using the plurality of first coupling capacitance values to form a first oscillation frequency-capacitance curve; an analyzing unit for analyzing the first oscillation frequency-capacitance curve according to a predetermined rule to determine a type of the first touch control operation and/or information of source of the operational body.

In some embodiments, the capacitive touch screen according to the embodiment of the present invention further includes a storing unit for pre-storing an oscillation frequency-capacitance curve, wherein the analyzing unit matches the first oscillation frequency-capacitance curve to the pre-stored oscillation frequency-capacitance curve, different curves in the pre-stored oscillation frequency-capacitance curve can be used to characterize different types of the first touch control operation and/or the information of the source of the operational body.

In some embodiments, in the capacitive touch screen according to the embodiment of the present invention, the operational body is a finger of the user, and the information of the source of the operational body refers to information of identity of the user.

In some embodiments, in the capacitive touch screen according to the embodiment of the present invention, the analyzing unit analyzes curve characteristics of the first oscillation frequency-capacitance curve to determine a type of the first touch control operation and/or the information of the source of the operational body.

In some embodiments, in the capacitive touch screen according to the embodiment of the present invention, the operational body is a handwritten pen, and the information of the source of the operational body refers to information of the manufacturer of the handwritten pen.

In some embodiments, in the capacitive touch screen according to the embodiment of the present invention, when the analyzing unit determines that the type of the first touch control operation and/or the information of the source of the operational body do not conform to a predetermined condition, the control unit performs a control so as not to respond to the first touch control operation.

With the capacitive touch screen and the information processing method therefor according to the embodiments of the present invention, touch information of more dimensions can be implemented by adopting a method of multi-frequency point sampling. In addition, there is no need of adding new hardware, only software of the controller of the touch screen needs to be modified.

### BRIEF DESCRIPTION OF THE DRAWINGS

FIG. 1 is a flow chart showing procedure of an information processing method applied in a capacitive touch screen according to the embodiment of the present invention; and

FIG. 2 is a functional block diagram showing configuration of the capacitive touch screen according to the embodiment of the present invention.

### DETAILED DESCRIPTION

The respective preferable embodiments of the present invention are described with reference to the accompanying drawings hereinafter. The description with reference to the accompanying drawings is provided hereinafter to help to understand the exemplified embodiment of the present invention defined by the claim or the equivalent. It comprises various kinds of specific details helping understanding, and they are only regarded as schematically. Therefore, those skilled people in the art would recognize that the embodiments described here might be made various kinds of alternation and modification without departing from the range and spirit of the present invention. Further, in order to make the specification much clearer and briefer, the detailed description on the well-known function and structure in the art would be omitted.

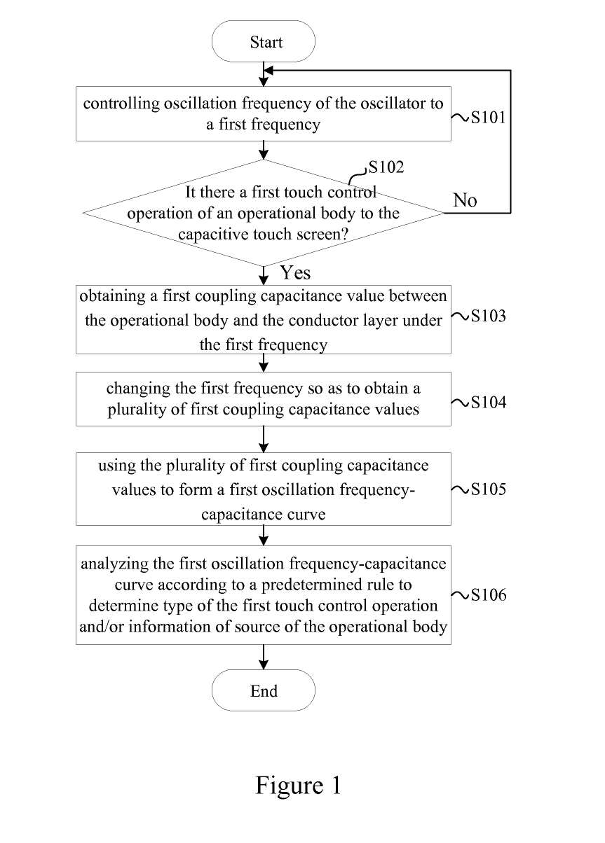

Firstly, the information processing method applied in the capacitive touch screen according to the embodiment of the present invention is described with reference to FIG. 1, here, the capacitive touch screen is provided with a conductor layer and an oscillator for generating an alternate current signal.

As shown in FIG. 1, the method includes steps of firstly, in step S101, an oscillation frequency of the oscillator is controlled to a first frequency. Then, in step S102, whether there is a first touch control operation of an operational body to the capacitive touch screen is decided.

If it is decided that there is the first touch control operation of the operational body to the capacitive touch screen in step S102, the processing proceeds to step S103. In step S103, a first coupling capacitance value between the operational body and the conductor layer under the first frequency is obtained.

On the other hand, if it is decided that there is not the first touch control operation of the operational body to the capacitive touch screen in step S102, the processing returns to step S101.

After step S103, the processing proceeds to step S104. In step S104, the first frequency is changed to obtain a plurality of first coupling capacitance values. Here, each first frequency changed corresponds to different first coupling capacitance value.

Then, in step S105, a first oscillation frequency-capacitance curve is formed using the plurality of first coupling capacitance values. For example, its horizontal axis is the first oscillation frequency and its vertical axis is the first coupling capacitance value.

At last, in step S106, the first oscillation frequency-capacitance curve is analyzed according to a predetermined rule to determine a type of the first touch control operation and/or information of source of the operational body.

In particular, as one possible implementation mode, step S106 may include matching the first oscillation frequency-capacitance curve with a pre-stored oscillation frequency-capacitance curve, and different curves in the pre-stored oscillation frequency-capacitance curve can be used to characterize different types of the first touch control operation and/or the information of the source of the operational body.

It should be noted that, before the above-mentioned step S101, there is also a constructing step of the database of the oscillation frequency-capacitance curve. In the constructing step, the type of the first touch control operation and/or the information of the source of the operational body are known. In this case, corresponding oscillation frequency-capacitance curves are obtained as the above steps S101-S105. Then, the oscillation frequency-capacitance curves obtained are stored in association with the corresponding types of the first touch control operation and/or the information of the source of the operational body. Therefore, if there is a curve matching the first oscillation frequency-capacitance curve in the pre-stored oscillation frequency-capacitance curves, the type of the first touch control operation and/or the information of the source of the operational body can be decided. If there is not a curve matching the first oscillation frequency-capacitance curve in the pre-stored oscillation frequency-capacitance curves, the type of the first touch control operation and/or the information of the source of the operational body can't be recognized.

For example, the operational body in the above description can be a finger of a user. In this case, for example, the type of the first touch control operation in the above description may be a mono-finger click, a multi-finger slide, or the like. Moreover, the information of the source of the operational body refers to information of identity of the user, for example, user A or user B, or male user or female user.

Also for example, the operational body in the above description may be a handwritten pen. In this case, the information of the source of the operational body refers to information of manufacturer of the handwritten pen. Of course, those skilled in the art should understand that, the present invention is not limited to the above enumerated several examples, and any other possible examples are included in the scope of the present invention.

Of course, alternatively, as another possible implementation mode, step S106 may include analyzing curve characteristics of the first oscillation frequency-capacitance curve to determine the type of the first touch control operation and/or the information of the source of the operational body. Different from the embodiment in the above paragraphs, there is no pre-stored known type of the first touch control operation and/or information of the source of the operational body. Alternatively, by analyzing large amount of curve characteristics of the oscillation frequency-capacitance curve, empirical data for deciding the type of the first touch control operation and/or the information of the source of the operational body is obtained. For example, when the curve rises sharply, the type of the first touch control operation is relatively possible as a multi-finger slide, and when the curve rises gently, the type of the first touch control operation is relatively possible as a mono-finger click. Also for example, when the curve rises sharply and in a case that the operational body is a finger of the user, the user is relatively possible a male user, and when the curve raises gently, the user is relatively possible a female user. Of course, those skilled in the art can understand, the present invention is not limited to the above enumerated several examples. In order for simplicity, such empirical data is no longer listed.

After step S106, when it is determined that the type of the first touch control operation and/or the information of the source of the operational body do not conform to a predetermined condition, the first touch control operation is not responded. That is, the type of the first touch control operation and/or the information of the source of the operational body are as authentication information, and if the authentication is successful, the corresponding operation is executed. Otherwise, the operation is not executed. For example, in a case that a document is a secret document that only a specific user A has authority to view, when the user B clicks the icon of the document by finger, since it is determined that the identity of the user does not conform to the condition, the operation of opening the document is no responded. For example, in this case, prompt information of authentication failure can be displayed to the user.

Different responses can be made when different first touch control operations are recognized. Next, it describes by taking photo in an album as example.

As a first example, if one photo in the album is made a mono-finger click, then basic information of this photo is displayed in response; in contrast, if one photo in the album is made a multi-finger click, detailed information of this photo is displayed in response.

As a second example, if one photo in the album displayed currently is made a mono-finger slide, the operation carried out in response is viewing the previous or next photo of the current photo, here, it needs to explain that viewing photo forwards or backwards depends on direction of the slide of the finger, for example, sliding leftwards corresponds to viewing the previous photo, and sliding rightwards corresponds to viewing the next photo; in contrast, if one photo in the album displayed currently is made a multi-finger slide, the operation carried out in response is viewing the previous or next several photos of the current photo. Here, the number of the photos scrolled can be determined according to the number of the finger sliding. For example, when two fingers slide, the number of the photos scrolled is 2, and when four fingers slide, the number of the photos scrolled is 4. Of course, when two fingers slide, the number of the photos scrolled may also be 20, and when four fingers slide, the number of the photos scrolled may be 40. Alternatively, the number of the photos scrolled can be pre-determined by the user regardless of the number of the finger sliding. For example, whether two fingers slide or four fingers slide, N pieces of photos are scrolled forwards or backwards as long as it is not a mono-finger slide, here, N is an arbitrary natural number larger than 1.

As a third example, if two fingers are getting close to each other on one photo in the album displayed currently, the operation carried out in response is to zoom out the photo displayed currently at a first speed; in contrast, if three fingers are getting close to each other on one photo in the album displayed currently, the operation carried out in response is to zoom out the photo displayed currently at a second speed, here, the first speed is less than the second speed.

It should be noted that, the above several cases are all examples, and the present invention is not limited thereto. Those skilled in the art can understand other examples of carrying out different response to different first touch control operations are possible.

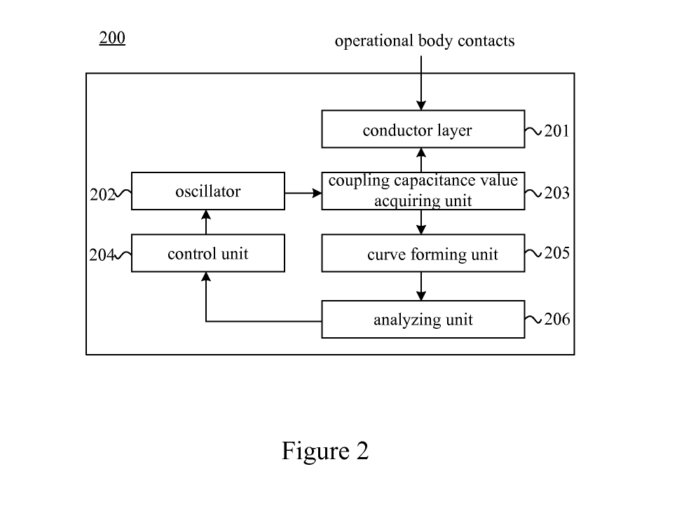

In the above paragraphs, the information processing method applied in a capacitive touch screen according to the embodiment of the present invention is described in detail. Next, the capacitive touch screen according to the embodiment of the present invention is described with reference to FIG. 2.

FIG. 2 illustrates a functional block diagram of configuration of the capacitive touch screen according to the embodiment of the present invention. As shown in FIG. 2, the capacitive touch screen 200 includes a conductor layer 201, an oscillator 202, a coupling capacitance value acquiring unit 203, a control unit 204, a curve forming unit 205 and an analyzing unit 206.

The conductor layer 201 is for forming a coupling capacitance in a case that an operational body contacts therewith.

The oscillator 202 converts a direct current supplied by system into a high frequency alternate current signal, and an oscillation frequency thereof is a first frequency.

The coupling capacitance value acquiring unit 203 obtains a first coupling capacitance value between the operational body and the conductor layer under the first frequency when the operational body carries out a first touch control operation to the capacitive touch screen 200.

The control unit 204 controls the oscillation frequency of the oscillator to the first frequency and changes the first frequency to obtain a plurality of first coupling capacitance values.

The curve forming unit 205 uses the plurality of first coupling capacitance values to form a first oscillation frequency-capacitance curve.

The analyzing unit 206 analyzes the first oscillation frequency-capacitance curve according to a predetermined rule to determine a type of the first touch control operation and/or information of source of the operational body.

As one implementation mode, the capacitive touch screen 200 can further include a storing unit 207. The oscillation frequency-capacitance curve is pre-stored in the storing unit 207. As above-mentioned, the type of the first touch control operation and/or the information of the source of the operational body corresponding to the pre-stored oscillation frequency-capacitance are known, and are stored in association with the oscillation frequency-capacitance curve.

In this case, the analyzing unit 206 matches the first oscillation frequency-capacitance curve to the pre-stored oscillation frequency-capacitance curve, and different curves in the pre-stored oscillation frequency-capacitance curve can be used to characterize different types of the first touch control operation and/or the information of the source of the operational body.

For example, the operational body is a finger of the user, the information of the source of the operational body refers to information of identity of the user. Also for example, the operational body is a handwritten pen, and the information of the source of the operational body refers to information of the manufacturer of the handwritten pen.

Of course, alternatively, as another implementation mode, the capacitive touch screen 200 may not include the storing unit 207 pre-storing the oscillation frequency-capacitance curve. In this case, the analyzing unit 206 analyzes curve characteristics of the first oscillation frequency-capacitance curve to determine the type of the first touch control operation and/or information of source of the operational body. For example, it is the multi-finger slide when the curve rises sharply, and it is the mono-finger click when the curve rises gently. Also for example, it is the male user when the curve rises sharply, and it is the female user when the curve rises gently, and so on.

The analyzing unit 206 provides the result of analysis to the control unit 204. When the analyzing unit 206 determines that the information of the identity of the user does not conform to a predetermined condition, the control unit 204 performs a control so as not to respond to the first touch control operation. At this time, prompt information of authentication failure can be displayed to the user.

It should be noted that, other than the control unit 204 controlling to change the oscillation frequency of the oscillator 202 to carry out multi-frequency point sampling and the analyzing unit determining the type of the touch control operation and/or the information of the source of the operational body by analyzing the oscillation frequency-capacitance curve, the capacitive touch screen 200 according to the embodiment of the present invention is same as the hardware configuration of the capacitive touch screen in the prior art in other aspects of the hardware configuration.

Since the capacitive touch screen according to the embodiment of the present invention fully corresponds to the information processing method mentioned above, the specific details are not described in detail in order for simplicity.

It should be noted that, in the specification, terms such as “comprise”, “include” and any other variation thereof intend to cover nonexclusive inclusion so that the procedure, the method, the product or the equipment including a series of elements not only include these elements, but also include other elements which are not listed explicitly, or also include inherent elements of these procedure, method, product or equipment. In a case that there is no more limitation, the element defined by statement “including one . . . ” does not exclude there is an additional same element in the procedure, method, article or apparatus including the element.

Finally, it should be noted that, a series of processing described above not only comprise processing executed chronologically in order mentioned here, but also comprise processing executed in parallel or individually but not chronologically.

With the description of the above implementation mode, those skilled in the art can clearly understand that the present invention can be implemented by means of software plus necessary software platform. Of course, it can be implemented by software totally. Based on such understanding, the technical solution of the present invention essentially or the part contributed to the description of the prior art can be embodied by a form of a software product, the computer software product can be stored in a storage medium, such as ROM/RAM, magnetic disc, optical disk or the like, it comprises some instructions to cause a computer equipment (it may be a personal computer, a server or a network equipment or the like) to execute the method according to the respective embodiments of a certain part of the embodiment of the present invention.

The present invention is described above in detail, the principle and implementation mode of the present invention are explained by applying some specific examples in the specification, the above explanation of the embodiments is only for helping to understand the method of the present invention and the essential spirit thereof, and, at the same time, for those skilled in the art, they can modify the specific implementation mode and application area based on the idea of the present invention, thus, in summary, the content of this specification should not be understood as a limitation to the present invention.

What is claimed is:

1. An information processing method applied in a capacitive touch screen provided with a conductor layer and an oscillator for generating an alternate current signal, the method comprising:
controlling an oscillation frequency of the oscillator to a first frequency;
obtaining a first coupling capacitance value between an operational body and the conductor layer under the first frequency when there is the operational body carrying out a first touch control operation to the capacitive touch screen;
changing the first frequency so as to obtain a plurality of first coupling capacitance values;
using the plurality of first coupling capacitance values to form a first oscillation frequency-capacitance curve; and
analyzing the first oscillation frequency-capacitance curve according to a predetermined rule to determine a type of the first touch control operation and/or information of source of the operational body.

2. The information processing method of claim 1, wherein the step of analyzing the first oscillation frequency-capacitance curve according to the predetermined rule is specifically: matching the first oscillation frequency-capacitance with a pre-stored oscillation frequency-capacitance curve, different curves in the pre-stored oscillation frequency-capacitance curve being able to be used to characterize different types of the first touch control operation and/or the information of the source of the operational body.

3. The information processing method of claim 1, wherein the operational body is a finger of a user, and the information of the source of the operational body refers to information of identity of the user.

4. The information processing method of claim 1, wherein the step of analyzing the first oscillation frequency-capacitance curve according to the predetermined rule is specifically: analyzing a curve characteristic of the first oscillation frequency-capacitance curve to determine the type of the first touch control operation and/or the information of the source of the operational body.

5. The information processing method of claim 1, wherein the operational body is a handwritten pen, and the information of the source of the operational body refers to information of manufacturer of the handwritten pen.

6. The information processing method of claim 1, wherein when it is determined that the type of the first touch control operation and/or the information of the source of the operational body do not conform to a predetermined condition, the first touch control operation is not responded.

7. A capacitive touch screen, comprising:
a conductor layer;
an oscillator for generating an alternate current signal and of which an oscillation frequency is a first frequency;
a coupling capacitance value acquiring unit for obtaining a first coupling capacitance value between an operational body and the conductor layer under the first frequency when there is the operational body carrying out a first touch control operation to the capacitive touch screen;
a control unit for controlling the oscillation frequency of the oscillator to a first frequency and changing the first frequency so as to obtain a plurality of first coupling capacitance values;
a curve forming unit for using the plurality of first coupling capacitance values to form a first oscillation frequency-capacitance curve; and
an analyzing unit for analyzing the first oscillation frequency-capacitance curve according to a predetermined rule to determine a type of the first touch control operation and/or information of source of the operational body.

8. The capacitive touch screen of claim 7, further comprising:
a storing unit for pre-storing an oscillation frequency-capacitance curve;
wherein the analyzing unit matches the first oscillation frequency-capacitance curve to the pre-stored oscillation frequency-capacitance curve, and different curves in the pre-stored oscillation frequency-capacitance curve can be used to characterize different types of the first touch control operation and/or the information of the source of the operational body.

9. The capacitive touch screen of claim 7, wherein the operational body is a finger of a user, and the information of the source of the operational body refers to information of identity of the user.

10. The capacitive touch screen of claim 7, wherein the analyzing unit analyzes curve characteristics of the first oscillation frequency-capacitance curve to determine the type of the first touch control operation and/or the information of the source of the operational body.

11. The capacitive touch screen of claim 7, wherein the operational body is a handwritten pen, and the information of the source of the operational body refers to information of manufacturer of the handwritten pen.

12. The capacitive touch screen of claim 7, wherein when the analyzing unit determines that the type of the first touch control operation and/or the information of the source of the operational body do not conform to a predetermined condition, the control unit performs a control so as not to respond to the first touch control operation.
